(19) United States
(12) Patent Application Publication
(10) Pub. No.: US 2016/0196769 A1
(43) Pub. Date: Jul. 7, 2016

(54) SYSTEMS AND METHODS FOR COACHING A MACHINE OPERATOR

(71) Applicant: Caterpillar Inc., Peoria, IL (US)

(72) Inventors: Jeffrey Graham FLETCHER, Peoria, IL (US); Jeffrey Stephen ALIG, Metamora, IL (US); Bradley Keith BOMER, Pekin, IL (US); Carl Phiroz DARUKHANAVALA, Peoria, IL (US); Zhijun CAI, Springfield, IL (US); Karl Arthur KIRSCH, Chillicothe, IL (US)

(73) Assignee: Caterpillar Inc., Peoria, IL (US)

(21) Appl. No.: 14/591,594

(22) Filed: Jan. 7, 2015

(51) Int. Cl. G09B 19/16; G06F 17/50

(52) U.S. Cl. CPC G09B 19/167; G06F 17/5009

(57) ABSTRACT

Systems and methods are disclosed for coaching an operator of a machine. According to certain embodiments, data describing operation of the machine by the operator is received. At least one operation requiring improvement is identified based on the received data and demonstrated to the operator. Moreover, the operator is trained on the at least one operation requiring improvement.

### TECHNICAL FIELD

The present disclosure generally relates to systems and methods for coaching a machine operator and, more particularly, to systems and methods for coaching a machine operator based on actual and ideal operation data.

### BACKGROUND

Machines used in earthmoving, industrial, and agricultural applications require considerable skill to operate. Such machines include, but are not limited to, wheel loaders, track-type tractors, motor graders, excavators, articulated trucks, pipe layers, backhoes, and the like. Operators of such machines must generally undergo extensive training in order to understand how to safely and efficiently operate the machine.

Existing training methods for machine operators include simulation-based training and in-cab training. Simulation systems (“simulators”) provide operators the ability to learn how to operate a machine to perform various tasks in a safe environment, without endangering others or negatively affecting production. While current simulators attempt to provide realistic representations of a real-world production environment, they cannot fully replicate the experience of operating a machine as intended in such an environment. In-cab training provides operators the opportunity to learn how to use a machine to perform tasks in the environment in which the machine was intended to perform those tasks, but inexperienced operators may pose dangers to nearby operators and others or otherwise negatively affect production (e.g., by occupying a machine that could be used by a more experienced operator to perform work).

One system for training a machine operator based on actual and simulated operation data is described in U.S. Pat. No. 7,424,414. The '414 patent describes a system for providing training or instruction to a driver of a vehicle based on data collected from both a driving simulator and the vehicle. According to the '414 patent, such training or instruction may be provided to the driver by a person (e.g., an instructor) providing driving lessons or a machine (e.g., a driving simulator). Moreover, the feedback may include a rating or evaluation of the driver's performance based on predetermined driving standards.

Although the '414 patent discloses collection of actual operation data from a user's operation of a vehicle, the '414 patent fails to disclose incorporating that data into a simulated environment in a manner that enables the user easily to understand any errors made during operation of the vehicle. For example, the '414 patent discloses that data collected from a user's operation of a simulator and a vehicle may be used to train a user on how properly to operate the vehicle, but the '414 patent does not disclose utilizing the simulator to demonstrate to the user how the user's actual operation of the vehicle differed from the ideal operation of the vehicle. The '414 patent further fails to describe how the simulator may be used to improve the user's performance by incorporating data from the user's operation of the vehicle.

The present disclosure is directed to overcoming one or more of the problems set forth above and/or other problems in the art.

### SUMMARY OF THE INVENTION

In one aspect, the present disclosure is directed to a method for coaching an operator of a machine. The method is performed by one or more processors and includes receiving data describing operation of the machine by the operator. The method also includes identifying at least one operation requiring improvement based on the received data. Moreover, the method includes demonstrating the at least one operation requiring improvement to the operator. The method further includes training the operator on the at least one operation requiring improvement.

In another aspect, the present disclosure is directed to a non-transitory computer-readable storage medium storing instructions for coaching an operator of a machine. The instructions cause the at least one processor to perform operations including receiving data describing operation of the machine by the operator. The operations further include identifying at least one operation requiring improvement based on the received data and demonstrating the at least one operation requiring improvement to the operator. Further, the operations include training the operator on the at least one operation requiring improvement.

In yet another aspect, the present disclosure is directed to a system for coaching an operator of a machine. The system includes an operator input device and a controller operatively connected to the operator input device. The controller is configured to receive data describing operation of the machine by the operator. The controller is also configured to identify at least one operation requiring improvement based on the received data and demonstrate the at least one operation requiring improvement to the operator. Moreover, the controller is configured to train the operator on the at least one operation requiring improvement.

### BRIEF DESCRIPTION OF THE DRAWINGS

FIG. 1 is an illustration of an exemplary system environment for coaching a machine operator;

FIG. 2 is a block diagram of an exemplary earthmoving machine according to one embodiment of the present disclosure;

FIG. 3 is a block diagram of an exemplary earthmoving machine according to another embodiment of the present disclosure;

FIG. 4 is an illustration of an exemplary graphical user interface for use with an exemplary system for coaching a machine operator; and

FIG. 5 is a flow chart illustrating an exemplary disclosed method of coaching a machine operator.

### DETAILED DESCRIPTION

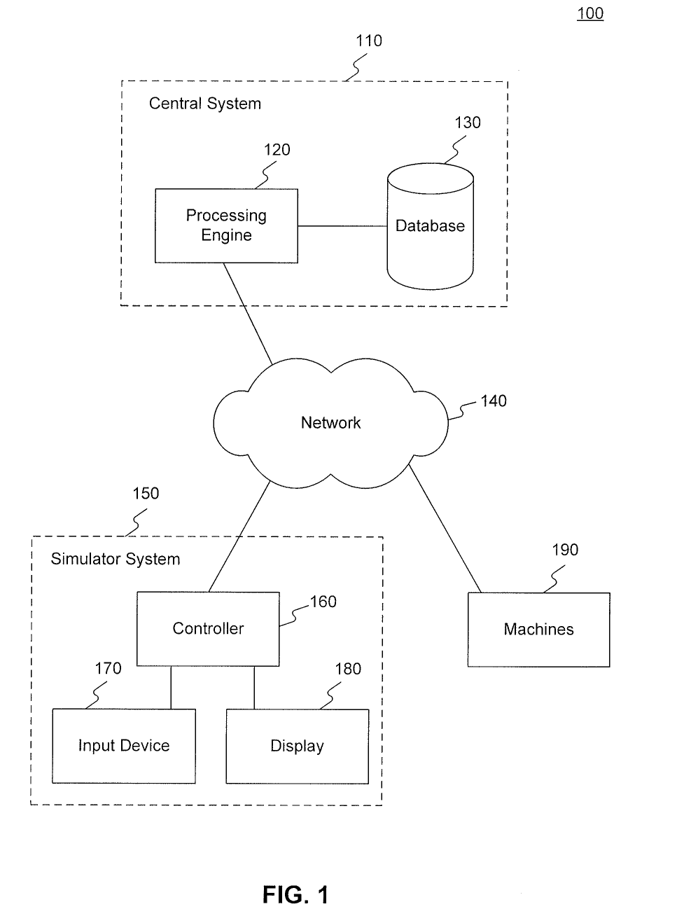

FIG. 1 depicts an exemplary system environment 100 for coaching a machine operator. As shown in FIG. 1, system environment 100 includes a number of components. It will be appreciated from this disclosure that the number and arrangement of these components is exemplary and provided for purposes of illustration. Other arrangements and numbers of components may be utilized without departing from the teachings and embodiments of the present disclosure.

As shown in FIG. 1, the exemplary system environment 100 includes a central system 110. Central system 110 may include one or more server systems, databases, and/or computing systems configured to receive information from entities over a network and process and/or store the information. In one embodiment, central system 110 may include a processing engine 120 and one or more databases 130, which are illustrated in a region bounded by a dashed line for central system 110 in FIG. 1. Database 130 may be any suitable combination of large scale data storage devices, which may optionally include any type or combination of slave databases, load balancers, dummy servers, firewalls, back-up databases, and/or any other desired database components.

In one embodiment, central system 110 may transmit and/or receive data to/from various other components of system environment 100, such as simulator system 150 and machines 190. More specifically, central system 110 may be configured to receive and store data transmitted over a network 140 (e.g., comprising the Internet) from various data sources (e.g., machines 190), process and/or store the received data, and transmit the data over the electronic network to consumers of the data (e.g., simulator system 150). For example, processing engine 120 may receive actual operation data from machines 190 and store the received data in database 130. Processing engine 120 may also receive a request for actual operation data from simulator system 150, access the data from database 130, and send the data to simulator system 150.

Simulator system 150 may represent one or more receiving, computing, and/or display systems of a business entity associated with machine 190, such as a manufacturer, dealer, retailer, owner, service provider, client, or any other entity that generates, maintains, sends, and/or receives information associated with machine 190. The one or more computing systems may embody, for example, a machine simulator, a mainframe, a work station, a laptop, a personal digital assistant, and other computing systems known in the art. Simulator system 150 may include components such as, for example, a memory, one or more data storage devices, a controller 160, or any other components that may be used to run an application or a mathematical algorithm. In one aspect, simulator system 150 may include a firewall and/or require user authentication, such as a username and password, in order to prevent access thereto by unauthorized entities.

Controller 160 may perform algorithmic calculations through pre-programmed applications and/or algorithms. In one embodiment, controller 160 receives operation data from machine 190 and processes this data to simulate one or more operations of machine 190. In another embodiment, controller 160 receives operation data from central system 110 (e.g., operation data sent to central system 110 from machine 190) and processes this data to simulate one or more operations of a machine. Controller 160 may receive from central system 110 and machine 190 data describing actual operation of a machine (i.e., data recorded from an operator's use of a machine on a work site), as well as data describing ideal operation of the machine. For example, controller 160 may receive data describing an ideal set of operations that enable an efficient or optimal performance of the machine. In one embodiment, the ideal operation data may be received from central system 110 or machine 190. In an alternate embodiment, the ideal operation data is stored in local memory (e.g., a database) associated with simulator system 150.

Simulator system 150 may also include an input device 170 and a display 180. In one aspect, input device 170 may resemble the operator interface included on machine 190. For example, input device 170 may include an arrangement of joysticks, wheels, levers, pedals, switches, and/or buttons similar (or identical) to that of machine 190. Alternatively, input device 170 may be generic, and used for remote control of many different types of simulation-capable machines 190. However, it is to be appreciated that device 170 may simply embody one or more conventional computer interface devices, such as, for example, a keyboard, touchpad, mouse, or any other interface devices known in the art.

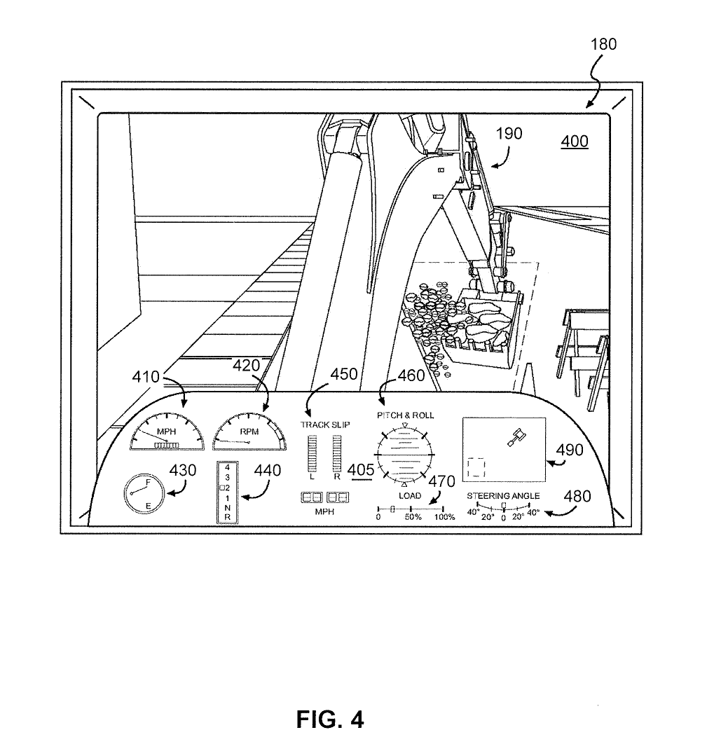

Display 180 may include a liquid crystal display (LCD), a CRT, a PDA, a plasma display, a touch-screen, a portable hand-held device, or any such display device known in the art. In one aspect, display 180 may comprise a full 360-degree display encompassing the operator for augmented, realistic display of a simulated work site. An exemplary user interface presented to an operator via display 180 is depicted in FIG. 4.

System environment 100 also includes one or more machines 190. In one embodiment, machine 190 is a machine or vehicle used in earthmoving, industrial, or agricultural applications. For example, machine 190 may be, without limitation, a wheel loader, an articulated truck, an excavator, a track-type tractor, a motor grader, a pipe layer, a backhoe, or the like. In another embodiment, machine 190 may be any other land-, marine-, or air-based vehicle.

In one embodiment, machine 190 collects and stores real-time operation data. For example, machine 190 may collect and store data describing inputs, outputs, and environmental conditions associated with the performance of one or more tasks by machine 190. This data may be transmitted (e.g., over network 140) to central system 110, simulator system 150, or other machines for storage, processing, and/or analysis.

The various components of system environment 100 may include an assembly of hardware, software, and/or firmware, including a memory, a central processing unit (“CPU”), and/or a user interface. Memory may include any type of RAM or ROM embodied in a non-transitory computer-readable storage medium, such as magnetic storage including floppy disk, hard disk, or magnetic tape; semiconductor storage such as solid state disk (SSD) or flash memory; optical disc storage; magneto-optical disc storage; or any other type of physical memory on which information or data readable by at least one processor may be stored. Singular terms, such as “memory” and “computer-readable storage medium,” may additionally refer to multiple structures, such a plurality of memories and/or computer-readable storage mediums. As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals. A CPU may include one or more processors for processing data according to a set of programmable instructions or software stored in the memory. The functions of each processor may be provided by a single dedicated processor or by a plurality of processors. Moreover, processors may include, without limitation, digital signal processor (DSP) hardware, or any other hardware capable of executing software. An optional user interface may include any type or combination of input/output devices, such as a display monitor, keyboard, and/or mouse.

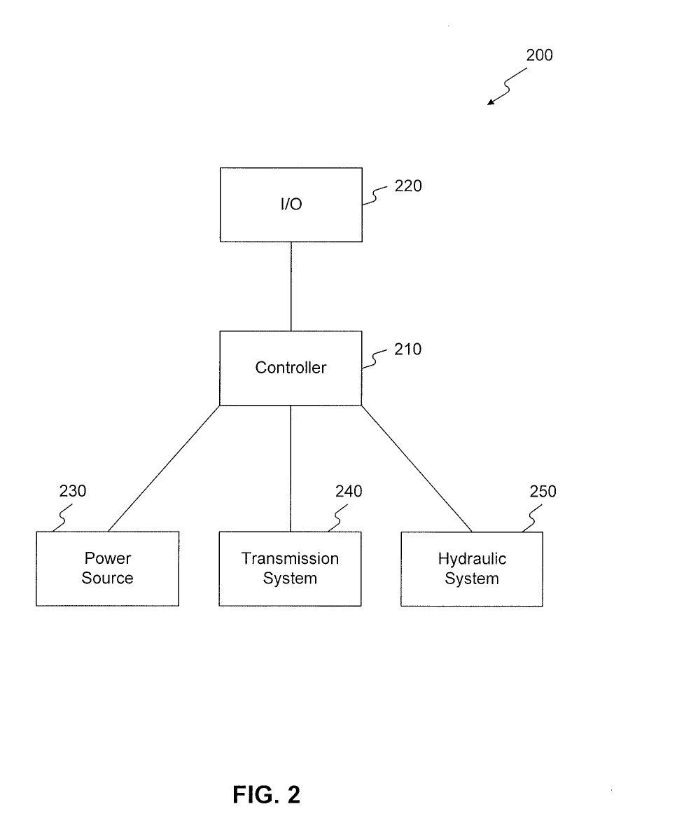

FIG. 2 depicts an exemplary system 200 of components of machine 190. As shown in FIG. 2, system 200 may comprise a controller 210 in communication with an input/output (I/O) device 220, power source 230, transmission system 240, and hydraulic system 250, all of which are part of machine 190. Controller 210 may comprise any non-transitory computer readable storage medium having stored thereon computer-executable instructions, such as, at least one processor, configured to manipulate machine 190.

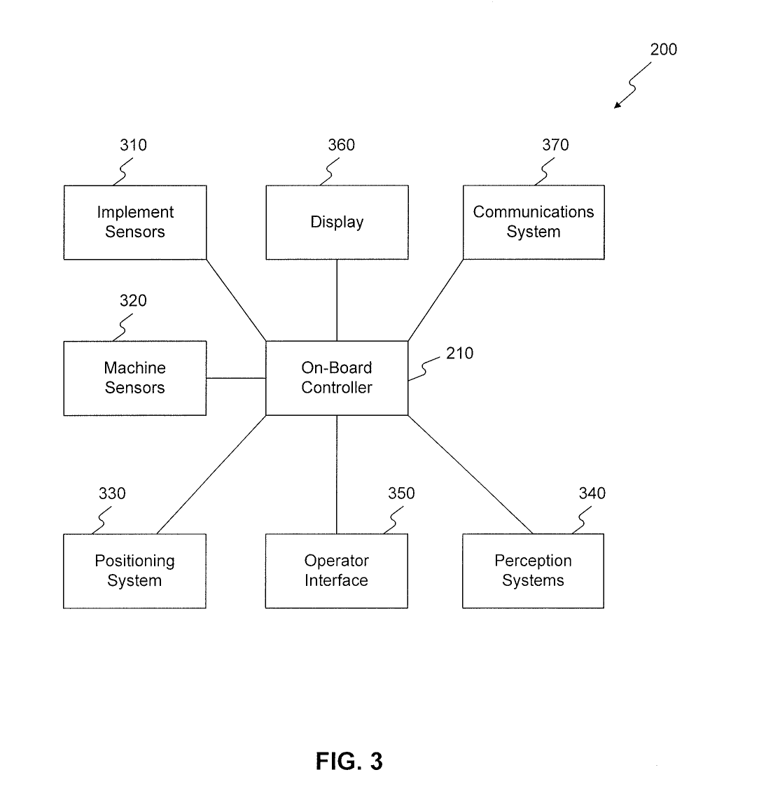

As shown in FIG. 3, system 200 may further comprise implement sensors 310, machine sensors 320, positioning system 330, perception systems 340, and communications system 370, in addition to the controller 210, input device or operator interface 350 and output device or display 360. Implement sensors 310 may comprise sensors configured to measure implement or tool position, load pressure, pin angle, actuator displacement, and the like. Machine sensors 320 may comprise sensors configured to measure machine speed, engine speed, transmission gear, steering angle, articulation angle, and the like.

Positioning system 330 may identify a current location, time or position of machine 190 and may comprise a navigation system which uses the global positioning system (GPS), an inertial measurement unit (IMU), a dead reckoning procedure, perception-based localization (PBL), or a combination thereof. System 200 may also comprise on-board and off-board perception systems 340, which may detect objects, personnel, or other machines close to machine 190. Perception systems 340 may use radar, lidar, cameras, or a combination thereof for object and personnel detection. Controller 210 may collect and store data (i.e., operation data) received from implement sensors 310, machine sensors 320, positioning system 330, and perception system 340 during operation of machine 190. Communications system 370 may send this data to central system 110, simulator system 150, or other machines via satellite, cellular, WiFi, Bluetooth, and/or other wired or wireless communication technologies. Likewise, communications system 370 may receive data from the various components of system environment 100 via communications satellite, cellular, WiFi, Bluetooth, and/or other wired or wireless communication technologies.

Display 360 may include a liquid crystal display (LCD), a CRT, a PDA, a plasma display, a touch-screen, a portable hand-held device, or any such display device known in the art. Operator interface 350 may include one or more inputs or controls used to operate machine 190, such as an arrangement of joysticks, wheels, levers, pedals, switches, and/or buttons.

FIG. 4 shows an exemplary graphical user interface for use with an exemplary system for coaching a machine operator. In one embodiment, the exemplary graphical user interface shown in FIG. 4 is presented using a display (e.g., display 180) of a simulator system (e.g., simulator system 150).

As illustrated in FIG. 4, simulator system 150 may generate and display one or more selectable viewpoint perspectives 400 of machine 190 on display 180. For example, simulator system 150 may display a view of a work site based on data collected from machine 190 during operation at the work site. In addition, simulator system 150 may display an information panel 405, which may include a plurality of indicators 410-490 associated with respective parameter values derived from the data collected from machine 190.

For example, panel 405 may include a machine ground speed indicator 410 to show the ground speed of the machine (mph or km/h), an engine speed indicator 420 to show the engine rotational speed (RPM), a fuel level indicator 430, and/or a transmission output ratio (gear) indicator 440. Further, panel 405 may include slip indicator 450 to identify a rate at which traction devices may be slipping. For example, slip indicator 450 may show that the left track is slipping at a rate of 0.2 mph. Panel 405 may also include a machine roll and pitch indicator 460 to provide the operator with present inclination angles of machine with respect to horizontal ground (e.g., 20-degree pitch and 12-degree roll). Additionally, panel 405 may include a loading indicator 470 to show a capacity to which tool 20 is filled (e.g., 25%), and/or a steering command indicator 480 to show a present steering angle of traction devices 30 (e.g., 22-degrees left). Panel 405 may include other indicators, such as, for example, a machine positioning indicator 490 showing a vertical overhead view of the position of machine relative to work site (e.g., a machine icon positioned on a map of work site). Alternatively or additionally, machine position indicator 490 may indicate present latitude and longitude, and/or other coordinates representing a current position of machine 190 with respect to a work site. It is to be appreciated that any other parameter values of interest may be selectively provided in panel 405 based on the received machine data (e.g., the actual or ideal operation data) in order to provide an augmented reality for the machine operator.

Simulator system 150 may generate and display one or more selectable viewpoint perspectives 400 of machine 190 on display 180 based on data received from machine 190 or central system 110, or stored in local storage (e.g., a database) of simulator system 150, describing an actual or ideal operation of machine 190 to perform one or more tasks. Accordingly, an operator of simulator system 150 may be provided with the same views of a work site at which machine 190 performed the one or more task as observed by the operator who performed those tasks with machine 190. In addition to the work site, simulator system 150 may also display the same indicators (e.g., via information panel 405) that were displayed to the operator of machine 190 during the performance of the one or more tasks or that would be displayed to the operator in an ideal performance of the one or more tasks. Thus, the operator of simulator system 150 will understand how machine 190 was operated during the prior performance of the one or more tasks, or how machine 190 would be operating during an ideal performance of the one or more tasks, both in terms of the external physical environment (e.g., worksite) and the internal machine environment (e.g., information panel 405). The operator may use this information to improve his or her operation of machine 190 to execute the tasks in the future.

In one embodiment, simulator system 150 may analyze data from an actual operation of machine 190 to identify a set of tasks performed by machine 190. Data from the actual operation of each task may be compared to data describing an ideal operation of machine 190 to perform the task. Based on this comparison, simulator system 150 may determine a rating for the actual operation of machine 190 to perform the task. This rating may represent the machine operator's efficiency with respect to performance of the task. In one embodiment, simulator system 150 may identify one or more coaching points based on the rating. For example, if an operator's rating for performance of a task falls below a threshold rating, simulator system 150 may designate the operation as operation requiring improvement and provide the operator with training regarding the ideal operation of the task.

In one embodiment, simulator system 150 may simultaneously display the actual operation of machine 190 by an operator performing a task and the ideal operation of machine 190 to perform the task. For example, the actual operation and ideal operation may be synchronized and displayed to an operator side-by-side on display 180, so that the operator may compare the actual operation of machine 190 at a work site to perform a task with the ideal operation of machine 190 to perform the task. This may enable the operator to identify areas for improvement in the operator's use of machine 190 to perform the task.

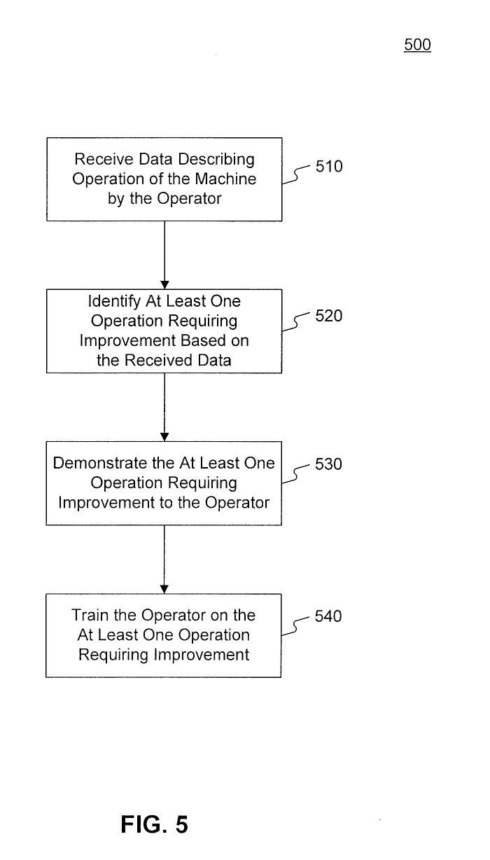

In accordance with certain embodiments, actual operation data is collected from a machine as it is used to perform one or more tasks for an operator. The actual operation data is transmitted to a simulator. The simulator may analyze the actual operation data and identify instances in which the operation of the machine may be improved based on ideal operation data. The simulator may train the operator on how to improve his or operation of the machine, for example, by displaying the operator's technique along with the ideal technique and enabling the operator to practice the operation using the simulator. The operator may be rated on the operations and practice until the operator's rating exceeds a threshold. FIG. 5, discussed below, provides further detail regarding techniques for coaching a machine operator.

### INDUSTRIAL APPLICABILITY

The disclosed systems and methods for coaching a machine operator may be utilized to improve operator skills and, thus, improve operation efficiency. In particular, the disclosed systems and methods may analyze actual operation data to identify less than desirable operator techniques. The operators may receive training on these techniques using a simulator, such as by viewing the operator's operation of the machine alongside an ideal operation of the machine and practicing the operation of the machine using the simulator. Unlike in-cab training, simulator training allows operators to improve operation techniques with minimal impact on production (e.g., other higher-skilled operators can use the machine while the less-skilled operator is training on the simulator) and minimal risk to others (e.g., no danger of harming others on a work site because operation is simulated).

FIG. 5 depicts an exemplary flow of a process 500 for coaching a machine operator, in accordance with an embodiment of the present disclosure. The steps associated with this exemplary process may be performed by the components of FIG. 1. For example, the steps associated with the exemplary process of FIG. 5 may be performed by controller 160, input device 170, and/or display 180 of simulator system 150 illustrated in FIG. 1.

In step 510, data describing operation of a machine by an operator is received by a simulator. In one embodiment, the received data is actual operation data collected by the machine during the operation of the machine by the operator. The actual operation data may include data observed and/or collected by implement sensors (e.g., tool position, load pressure, pin angle, actuator displacement), machine sensors (e.g., machine speed, engine speed, transmission gear, steering angle, articulation angle), positioning system (e.g., location, time or position), perception system (e.g., objects, personnel, other machines nearby), or other components of a machine. Moreover, the actual operation data may include images and/or video of the machine's surroundings during the operation.

In one embodiment, a machine provides actual operation data to a central system for storage and/or processing. The central system may then forward the actual operation data to a simulator or other machine for processing, analysis, and/or presentation. In an alternate embodiment, a machine provides actual operation data directly to a simulator or to other machines. The machines, central system, and/or simulator may transmit and/or receive the actual operation data via satellite, cellular, WiFi, Bluetooth, or other wired or wireless communication technologies. In one embodiment, the machines, central system, and/or simulator transmit and receive data over an electronic network, such as the Internet. In an alternate embodiment, the machines, central system, and/or simulator transmit and/or receive data via peer-to-peer communication (e.g., Bluetooth). In yet another embodiment, the actual operation data may be collected by the machine and stored in portable memory, which may be removed from the machine and loaded into the simulator.

In step 520, at least one operation requiring improvement may be identified based on the received data. In one embodiment, the simulator may analyze the received data and identify one or more tasks performed by the operator using the machine based on the analysis. For example, the simulator may determine based on the received data that an operator performed three tasks using the machine: (1) picking up an object, (2) transporting the object to a new location, and (3) placing the object at the new location. The simulator may determine a rating for the operator's performance of each of the one or more identified tasks. For example, the simulator may compare data corresponding to the operator's performance of a task (i.e., actual operation data) to data associated with an ideal performance of the task (i.e., ideal operation data) and rate the operator's performance of the task based on the similarity of the operator's performance of the task (i.e., series of steps taken by the operator to perform the task) to the ideal performance of the task (e.g., optimal series of steps to perform the task). The operator's performance of an identified task may be designated as an operation requiring improvement when the rating for the task is below a threshold rating.

In one embodiment, the simulator may display a list of tasks for which the operator's performance rated below a threshold value. The operator may select one of the identified tasks to receive training on how to improve the operator's performance of the task. In step 530, the at least operation requiring improvement is demonstrated to the operator. In one embodiment, the simulator demonstrates the at least one operation requiring improvement to the operator by recreating a plurality of conditions of the machine corresponding to the at least one operation requiring improvement based on the received data. For example, the simulator may display a visual representation (e.g., images or video) of the operator's performance of the task using the machine, which may include a depiction of the machine's external environment (e.g., work site) and internal environment (e.g., information panel, controls, other indicators).

In an alternate embodiment, the machine may analyze the actual operation data, determine the one or more tasks, identify at least one operation requiring improvement, and send the data corresponding to the operation requiring improvement to the simulator. Thus, the simulator may receive the data regarding the operation requiring improvement from the machine and train the operator based on that data, rather than analyzing all actual operation data to identify the operation requiring improvement.

In step 540, the simulator trains the operator on the at least one operation requiring improvement. In one embodiment, training the operator on the at least one operation requiring improvement includes demonstrating an ideal operation to the operator. Moreover, in one embodiment, training the operator on the at least one operation requiring improvement includes enabling the operator to practice the at least one operation requiring improvement one or more times using the simulator. For example, the simulator may recreate a set of conditions similar to those experienced by the operator when operating the machine to execute a task, and the operator may operate the simulator just as the operator would operate the machine. The simulator may determine a score for each practice execution of the task corresponding to the operation requiring improvement, for example, based on a comparison of the steps performed by the operator to an ideal set of steps to perform the operation. When the determined score exceeds a threshold score, the simulator may determine that the operator's training with respect to that task is complete.

Several advantages over the prior art may be associated with the disclosed systems and methods for coaching a machine operator. Unlike the techniques described in the prior art, the disclosed techniques for coaching an operator of a machine may utilize actual operation data to identify less than desirable operator techniques and train the operator on those techniques using a simulator. Moreover, the disclosed techniques may present both the actual operation of the machine and the ideal operation of the machine to make clear to the operator how operation may be improved.

It will be apparent to those skilled in the art that various modifications and variations can be made to the disclosed systems and methods for coaching a machine operator. Other embodiments will be apparent to those skilled in the art from consideration of the specification and practice of the disclosed systems and methods for coaching a machine operator. It is intended that the specification and examples be considered as exemplary only, with a true scope being indicated by the following claims and their equivalents.

What is claimed is:

1. A method for coaching an operator of a machine, the method comprising the following steps performed by one or more processors:
receiving data describing operation of the machine by the operator;
identifying at least one operation requiring improvement based on the received data;
demonstrating the at least one operation requiring improvement to the operator; and
training the operator on the at least one operation requiring improvement.

2. The method of claim 1, wherein receiving data describing operation of the machine by the operator comprises receiving data from the machine via satellite, cellular, WiFi, or Bluetooth communication.

3. The method of claim 1, wherein identifying at least one operation requiring improvement based on the received data comprises:
analyzing the received data;
identifying one or more tasks performed by the operator using the machine based on the analysis;
determining a rating for performance of each of the one or more identified tasks by the operator; and
designating the performance of an identified task as operation requiring improvement when the rating for the task is below a threshold rating.

4. The method of claim 3, wherein determining the rating for performance of an identified task comprises comparing the received data to data associated with an ideal performance of the identified task.

5. The method of claim I, wherein demonstrating the at least one operation requiring improvement to the operator comprises recreating a plurality of conditions of the machine corresponding to the at least one operation requiring improvement based on the received data.

6. The method of claim 1, wherein training the operator on the at least one operation requiring improvement comprises demonstrating an ideal operation to the operator.

7. The method of claim 1, wherein training the operator on the at least one operation requiring improvement comprises:
enabling the operator to practice the at least one operation requiring improvement one or more times;
determining a score for each of the one or more times; and
determining that training is complete when the determined score exceeds a threshold score.

8. A non-transitory computer-readable storage medium storing instructions for coaching an operator of a machine, the instructions causing at least one processor to perform operations comprising:
receiving data describing operation of the machine by the operator;
identifying at least one operation requiring improvement based on the received data;
demonstrating the at least one operation requiring improvement to the operator; and
training the operator on the at least one operation requiring improvement.

9. The non-transitory computer-readable storage medium of claim 8, wherein the instructions cause the at least one processor to identify at least one operation requiring improvement based on the received data by:
analyzing the received data;
identifying one or more tasks performed by the operator using the machine based on the analysis;
determining a rating for performance of each of the one or more identified tasks by the operator; and
designating the performance of an identified task as operation requiring improvement when the rating for the task is below a threshold rating.

10. The non-transitory computer-readable storage medium of claim 9, wherein the instructions cause the at least one processor to determine the rating for performance of an identified task by comparing the received data to data associated with an ideal performance of the identified task.

11. The non-transitory computer-readable storage medium of claim 8, wherein the instructions cause the at least one processor to demonstrate the at least one operation requiring improvement to the operator by recreating a plurality of conditions of the machine corresponding to the at least one operation requiring improvement based on the received data.

12. The non-transitory computer-readable storage medium of claim 8, wherein the instructions cause the at least one processor to train the operator on the at least one operation requiring improvement by demonstrating an ideal operation to the operator.

13. The non-transitory computer-readable storage medium of claim 8, wherein the instructions cause the at least one processor to train the operator on the at least one operation requiring improvement by:
enabling the operator to practice the at least one operation requiring improvement one or more times;
determining a score for each of the one or more times; and
determining that training is complete when the determined score exceeds a threshold score.

14. A system for coaching an operator of a machine, comprising:
an operator input device; and
a controller operatively connected to the operator input device, the controller being configured to:
receive data describing operation of the machine by the operator;
identify at least one operation requiring improvement based on the received data;
demonstrate the at least one operation requiring improvement to the operator; and
train the operator on the at least one operation requiring improvement.

15. The system of claim 14, wherein the controller is configured to receive data describing operation of the machine by the operator by receiving data from the machine via satellite, cellular, WiFi, or Bluetooth communication.

16. The system of claim 14, wherein the controller is configured to identify at least one operation requiring improvement based on the received data by:
analyzing the received data;
identifying one or more tasks performed by the operator using the machine based on the analysis;
determining a rating for performance of each of the one or more identified tasks by the operator; and
designating the performance of an identified task as operation requiring improvement when the rating for the task is below a threshold rating.

17. The system of claim 16, wherein the controller is configured to determine the rating for performance of an identified task by comparing the received data to data associated with an ideal performance of the identified task.

18. The system of claim 14, wherein the controller is configured to demonstrate the at least one operation requiring improvement to the operator by recreating a plurality of conditions of the machine corresponding to the at least one operation requiring improvement based on the received data.

19. The system of claim 14, wherein the controller is configured to train the operator on the at least one operation requiring improvement by demonstrating an ideal operation to the operator.

20. The system of claim 14, wherein the controller is configured to train the operator on the at least one operation requiring improvement by:
enabling the operator to practice the at least one operation requiring improvement one or more times;
determining a score for each of the one or more times; and
determining that training is complete when the determined score exceeds a threshold score.
